(19) United States
(12) Patent Application Publication
(10) Pub. No.: US 2006/0204348 A1
(43) Pub. Date: Sep. 14, 2006

(54) Self-attaching fastener and fastener and panel assembly

(76) Inventor: David M. Shuart, Royal Oak, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/074,907

(22) Filed: Mar. 8, 2005

(51) Int. Cl. F16B 39/00

(52) U.S. Cl. 411/107

(57) ABSTRACT

A self-attaching fastener for attachment to a panel including a body portion having an annular concave radial outer surface, and a radial flange portion having a diameter greater than the body portion including a bearing face receiving the panel having a plurality of integral circumferentially spaced ribs generally triangular in plan view having a greater circumferential width adjacent an outer surface of the flange than adjacent the annular concave radial outer surface of the body portion. The self-attaching fastener provides improve torque resistance and push-off strength when installed in a panel.

### FIELD OF THE INVENTION

This invention relates to a self-attaching or self-clinching fastener for attachment to a panel and a fastener and panel assembly having improved torque resistance and push-off strength. More specifically, this invention relates to a self-clinching and self-locking fastener and fastener and panel assembly which prevents rotation of the fastener relative to a panel and prevents push-off of the fastener following installation in a panel.

### BACKGROUND OF THE INVENTION

Cold formed self-attaching fasteners, including self-clinching nuts and studs, typically include anti-rotation means, such as grooves, ribs, protuberances or the like, to prevent rotation of the fastener following installation in a metal panel or plate. As will be understood by those skilled in this art, a pierce or clinch nut or stud is adapted to be installed in a metal panel, typically in a press, and then utilized to attach another element to the metal panel, such as a bracket, a second panel or another component, with a second fastener threadably received by the self-attaching fastener. Where the self-attaching fastener is a clinch nut, for example, a bolt or screw is threadably received in the bore of the nut. Where the self-attaching fastener is a stud, a nut or other female fastener is threadably received on the shank of the stud. In mass production applications, the second fastener is typically threaded to the self-attaching fastener with a torque wrench which applies a significant torque to the second fastener during threading. In most applications, it is critical that the self-attaching fastener does not rotate relative to the metal panel following installation, which is an object of this invention.

Another object of this invention is to provide improved push-off strength of the self-attaching fastener following installation in a metal panel. Push-off strength is the force required to push the self-attaching fastener off of the panel in the opposite direction of the installation. In many applications, the self-attaching fastener is first attached to a metal panel and clinched. This method of installation is also utilized for self-piercing fasteners, wherein the fastener pierces an opening in the metal panel and the fastener is then clinched to the panel either by deforming the metal panel or by deforming the self-piercing fastener. Thus, the term “self-clinching fastener” as used herein is generic to self-piercing and self-clinching fasteners, including self-clinching nuts and studs. In a typical automotive application, the self-attaching fastener is first attached to a metal panel by clinching in one station or location and the other element is attached to the panel by a second fastener at a second location. In such applications, a metal panel with several self-attaching fasteners may be moved from station to station prior to attachment of another element to the metal panel. In such applications, it is also critical that the self-attaching fastener remains firmly attached to the metal panel during handling of the metal panel. Thus, improved push-off strength is also an object of this invention.

### SUMMARY OF THE INVENTION

The self-attaching fastener of this invention is adapted for attachment to a metal panel and includes a body portion having an annular concave radial outer surface. In a disclosed preferred embodiment, this annular concave radial outer surface of the body portion is generally V-shaped including a face which is inclined inwardly from the top surface of the body portion at an angle of between 50 and 80 degrees, more preferably between 60 and 75 degrees or about 70 degrees, and in a preferred embodiment, the transition between the top surface of the body portion, which in a preferred embodiment is inclined upwardly at an angle of between 5 and 20 degrees, or more preferably about 10 degrees, is arcuate.

The self-attaching fastener of this invention also includes a radial flange portion adjacent to and integral with the body portion having a diameter greater than the body portion including a bearing face which receives the metal panel extending radially from the annular concave radial outer surface of the body portion. The bearing face of the flange portion further includes a plurality of integral circumferentially spaced ribs which project from the bearing face, each having a circumferential width adjacent the outer surface of the flange portion greater than a circumferential width adjacent the annular concave radial outer surface of the body portion. In one preferred embodiment, the radial ribs are triangular in plan view. That is, the top faces, which are spaced above the plane of the bearing face, are triangular, preferably in the general form or shape of an equilateral triangle. The triangular shape of the ribs provides improved torque resistance because torque applied to the self-attaching fastener during threading of a second fastener to the self-attaching fastener increases with the radius of the torque applied. Thus, ribs having a greater circumferential width at the outer surface of the flange portion than adjacent the annular concave radial outer surface of the body portion or generally triangular ribs will have greater strength or torque resistance at the outer surface of the ribs and better prevent rotation of the self-attaching fastener relative to the metal panel. In a preferred embodiment of the self-attaching fastener of this invention, the side faces of the ribs extend generally perpendicular to the top faces and the bearing face of the flange portion or the side faces may be inclined slightly depending upon the application.

The self-attaching fastener and metal panel assembly of this invention includes a self-attaching fastener, as described above, and a metal panel having a thickness generally equal to or slightly less than the distance between the top surface of the body portion and the bearing face of the flange portion or the height of the inclined face of the annular concave radial outer surface of the body portion. The panel is deformed against the top faces of the plurality of circumferentially spaced ribs and between the ribs against the bearing face of the flange portion, providing improved torque resistance. Additionally, the panel is deformed radially inwardly beneath the annular concave radial outer surface of the body portion, providing improved push-off strength.

In one preferred embodiment of the self-attaching fastener of this invention, each of the ribs include an inner face spaced from the annular concave radial outer surface of the body portion, such that the top faces of the ribs form a truncated equilateral triangle and are thus generally triangular as described above. In the disclosed embodiment, the inner faces of the ribs are planar. In this embodiment, the panel is deformed between the inner ends of the ribs and the annular concave radial outer surface of the body portion, providing further improved push-off strength. In the disclosed embodiment, the angle formed between the side faces of the ribs is between 50 and 70 degrees or about 60 degrees and the ribs extend generally radially. Further, in this embodiment, the bearing face of the flange portion is planar or substantially flat and perpendicular to the axis of the body portion and the flange portion. However, as described below with reference to a second embodiment of the self-attaching fastener of this invention, the bearing face of the flange portion may also be frustoconical forming a curved surface, wherein the bearing face is inclined inwardly from the outer surface of the flange portion to the annular concave radial outer surface of the body portion.

A second preferred embodiment of the self-attaching fastener of this invention disclosed herein includes a body portion having an annular concave radial outer surface, as described above, and a radial flange portion including a frustoconical conical bearing face which, as described above, is inclined inwardly from the outer surface of the flange portion to the annular concave radial outer surface of the body portion, preferably at an angle of between 5 and 20 degrees, more preferably between 10 and 20 degrees or more preferably about 15 degrees. In this embodiment, the side faces of the ribs extend generally tangentially to the annular concave radial outer surface of the body portion and perpendicular to the frustoconical bearing face and the top faces of the ribs. Thus, in this embodiment, the top faces of the ribs are also inclined inwardly from the outer surface of the flange portion to the annular concave radial outer surface of the body portion and may be inclined at the same angle as or parallel to the frustoconical bearing face. In a preferred embodiment, the radial ribs have a circumferential width at the outer surface of the flange portion substantially greater than a circumferential width of the ribs adjacent the annular concave radial outer surface of the body portion or generally triangular in plan view as described above. In the disclosed embodiment, the inner ends of the ribs are integral with the annular concave radial outer surface of the body portion, but spaced below the top face. During installation of this embodiment of the self-attaching fastener of this invention, the metal panel is driven against the top faces of the ribs and against the frustoconical bearing face into the annular concave radial outer surface of the body portion, providing further improved push-off strength. In a preferred embodiment, the circumferential width of the ribs at the outer surface of the flange portion is substantially less than the width of the frustoconical bearing face between the ribs or about one-half of the width of the frustoconical bearing face between the ribs, such that more of the metal panel is driven against the frustoconical bearing face and into the annular concave radial outer surface of the body portion provided further improved push-off strength. Further, because the top faces of the ribs are spaced below the top face of the body portion, the metal panel will also be driven against the inclined top faces of the ribs into the annular concave radial outer surface of the body portion above the ribs, providing further improved push-off strength. In this embodiment, the height of the ribs measured between the top faces of the ribs and the bearing face of the flange portion is substantially less than the width or height of the annular concave radial outer surface of the body portion.

The disclosed embodiments of the self-attaching fastener of this invention are stud-type fasteners having a cylindrical shank portion integral with the body portion, preferably having a diameter less than the diameter of the body portion, and preferably having an axis coincident with the axis of the body portion and the flange portion, which may have a cylindrical outer surface. However, the outer surface of the flange portion may also be polygonal. Further, the shank portion may be threaded to receive a threaded nut or unthreaded to receive a thread forming or thread rolling female fastener. However, as described further below, the self-attaching fastener of this invention may also be a female fastener, wherein the body portion includes a cylindrical opening which may be threaded or unthreaded to receive a bolt or screw.

As will be understood by those skilled in this art, the following description of the preferred embodiments and the appended drawings described two alternative embodiments of a self-attaching fastener and self-attaching fastener and metal panel assembly of this invention, but various modifications may be made to the disclosed embodiments within the purview of the appended claims. Thus, this invention is not limited to the disclosed embodiments except as set forth in the appended claims. The preferred embodiments of the self-attaching fastener and fastener and panel assembly of this invention will be more fully understood from the following description of the preferred embodiments and the appended drawings, a brief description of which follows.

### BRIEF DESCRIPTION OF THE DRAWINGS

FIG. 1 is an end or plan view of one embodiment of a self-attaching fastener of this invention;

FIG. 2 is a side perspective view of the embodiment of the self-attaching fastener shown in FIG. 1;

FIG. 3 is an end or plan view of the self-attaching fastener shown in FIGS. 1 and 2 installed in a metal panel wherein the panel is only partially shown for clarity;

FIG. 4 is a cross-sectional view of FIG. 3 in the direction of view arrows 4-4;

FIG. 5 is an end or plan view of an alternative embodiment of the self-attaching fastener of this invention;

FIG. 6 is a side perspective view of the self-attaching fastener shown in FIG. 5;

FIG. 7 is an end or plan view of the embodiment of the self-attaching fastener shown in FIGS. 5 and 6 installed in a metal panel, wherein the metal panel is only partially shown for clarity; and

FIG. 8 is a cross-sectional view of FIG. 7 in the direction of view arrows 8-8.

### DESCRIPTION OF THE PREFERRED EMBODIMENTS

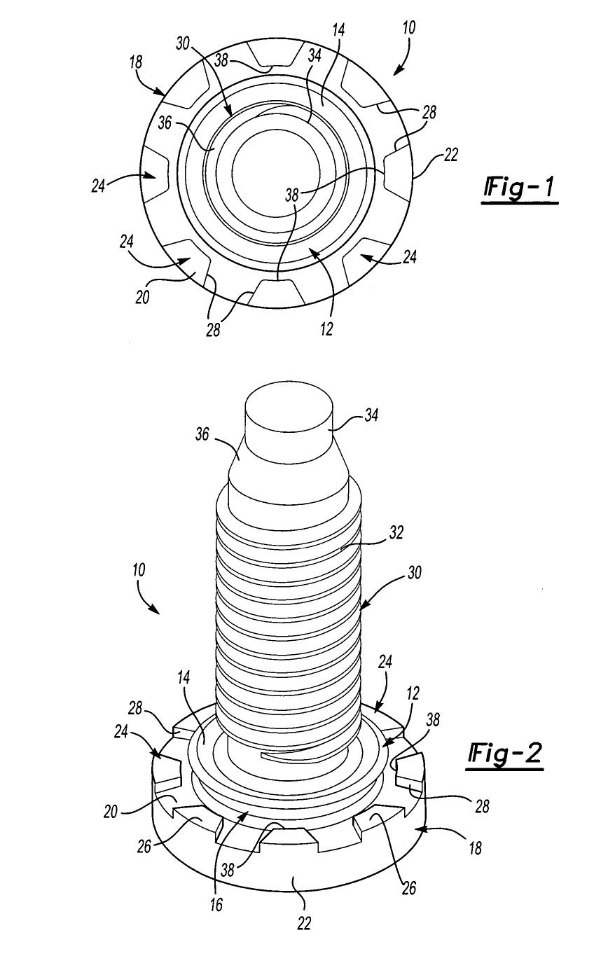

The embodiment of the self-attaching fastener 10 shown in FIGS. 1 and 2 includes a body portion 12 having an annular top face 14 and an annular concave radial outer surface 16. The self-attaching fastener 10 further includes a radial flange portion 18 which is integrally formed and coaxially aligned with the body portion 12 having an annular bearing face 20, an outer surface 22 which, in the disclosed embodiment, is cylindrical, including a plurality of integral circumferentially spaced ribs 24 which project from the annular bearing face 20 as shown in FIG. 2. Each of the circumferentially spaced ribs 24 include a generally triangular top face 26 and opposed side faces 28 which, in the disclosed embodiment, extend perpendicular to the top face 26 and the bearing face 20, such that the generally triangular top faces 26 of the ribs 24 are spaced above the plane of the bearing face 20. The embodiment of the self-attaching fastener 10 shown in FIGS. 1 and 2 is a male or stud-type fastener including fan integral shank portion 30 having external threads 32. The disclosed embodiment of the stud fastener disclosed in FIGS. 1 and 2 includes a cylindrical end portion 34 and a frustoconical portion 36.

In the embodiment of the self-attaching fastener 10 shown in FIGS. 1 and 2, the outer surface 22 of the radial flange portion 18 has a diameter substantially greater than the outer diameter of the body portion 12 and the diameter of the shank portion 30 is smaller than the diameter of the body portion 12, but the shank portion 30, body portion 12 and radial flange portion 18 are coaxially aligned. As set forth above, the self-attaching fastener of this invention may also be a female fastener, wherein the shank portion 30 is removed and the body portion 12 includes a cylindrical bore (not shown) which may be threaded or unthreaded. In the disclosed embodiment, the annular bearing face 20 of the flange portion 18 is planar or substantially flat, extending from the annular concave radial outer surface 16 of the body portion 12 to the outer surface 22 of the radial flange portion 18. However, as described below, the annular bearing face 20 may also be frustoconical. The generally triangular top faces 26 of the ribs 24 are generally in the shape of an equilateral triangle or more specifically a truncated equilateral triangle each having an inner end face 38 spaced from the annular concave radial outer surface 16 of the body portion 12 which, in the disclosed embodiment, is planar as shown. However, the inner end faces 38 of the ribs 24 may also be arcuate or even inclined upwardly from the annular bearing face 20 to the top faces 26, forming undercuts. The angle formed between the side faces 28 of the ribs 24 is preferably between about 50 and 70 degrees or more preferably about 60 degrees. As best shown in FIG. 4, the annular top face 14 of the body portion 12 is inclined upwardly as described above preferably at an angle of between 5 and 20 degrees and the annular concave radial outer surface 16 of the body portion 12 is generally V-shaped and defined by an inclined face 40 which is inclined upwardly from the annular bearing face 20 of the flange portion 18 to the top face 26, forming an undercut overlying the annular bearing face 20. In a preferred embodiment, the top face 26 joins the inclined face 40 in a convex arcuate surface 42 and the inclined face 38 joins the annular bearing face 20 in a concave arcuate surface 44 as shown in FIG. 4. In a preferred embodiment, the inclined face 40 is inclined relative to the annular bearing face 20 at an angle of between 50 and 80 degrees, or more preferably between 60 and 75 degrees or about 70 degrees.

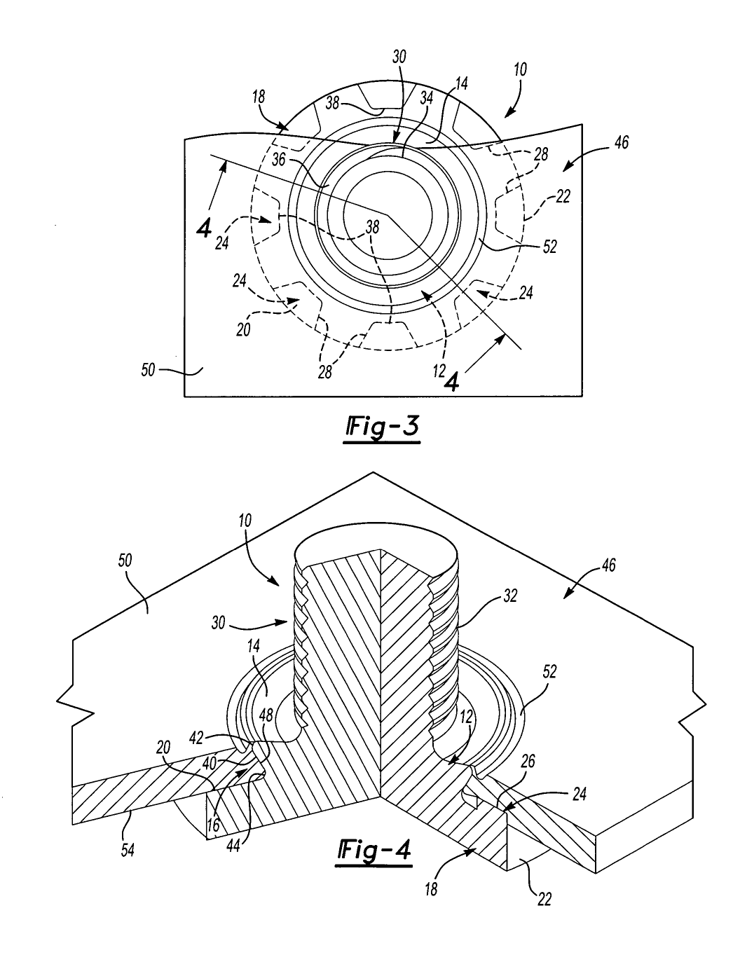

FIGS. 3 and 4 illustrate a self-attaching fastener and panel assembly utilizing the self-attaching fastener 10 shown in FIGS. 1 and 2. During installation of the self-attaching fastener 10 in a panel 46, an opening 48 is first formed in the panel having an internal diameter generally equal to for slightly greater than the external diameter of the body portion 12 and a die member or die button (not shown) is driven against the top surface 50 of the panel 46. As best shown in FIG. 4, the thickness of the panel 46 is preferably generally equal to or slightly less than the distance between the annular bearing surface 20 of the flange portion 18 and the top face 14 of the body portion 12 or stated another way, the width or height of the body portion 12 relative to the annular bearing face 20. The die member includes a clinching lip (not shown) which has a diameter slightly larger than the diameter of the top face 14, forming a circular groove 52 in the top surface 50 of the panel and the panel is thus driven against the top faces 26 of the ribs 24 and against the annular bearing face 20 of the radial flange portion 18. That is, the metal panel 50 is driven against the annular bearing face 20 between the circumferentially spaced ribs 24 and, in this embodiment, between the inner end faces 38 and the annular concave radial outer surface 18 of the body portion 12 as shown in FIG. 4. The panel 46 surrounding the panel opening 48 is also driven into the annular concave radial outer surface 16 and beneath the inclined face 40, preventing push-off of the fastener 10 relative to the panel 46. The circumferentially spaced ribs 24 are simultaneously driven into the bottom surface 54 of the panel 46, preventing rotation of the self-attaching fastener 10 relative to the panel 46. As set forth above, the torque applied to the self-attaching fastener 10 by threading a female fastener (not shown) on the threads 32 increases with the radius of the torque applied. Thus, generally triangular ribs 24 having a circumferential width adjacent the outer surface 22 of the flange portion 18_greater than the circumferential width of the ribs 26 adjacent the annular concave radial outer surface 16 will provide greater torque resistance than radial ribs having parallel side walls and the triangular shape of the ribs 24 will also provide a larger bearing surface 20 adjacent the body portion 12 improving push-off strength. Further, improved push-off strength is provided in this embodiment by spacing the ribs 24 from the annular concave radial outer surface 16, permitting the panel 46 to be driven into the space between the end faces 38 of the ribs 24 and the annular concave radial outer surface 16 of the body portion 12.

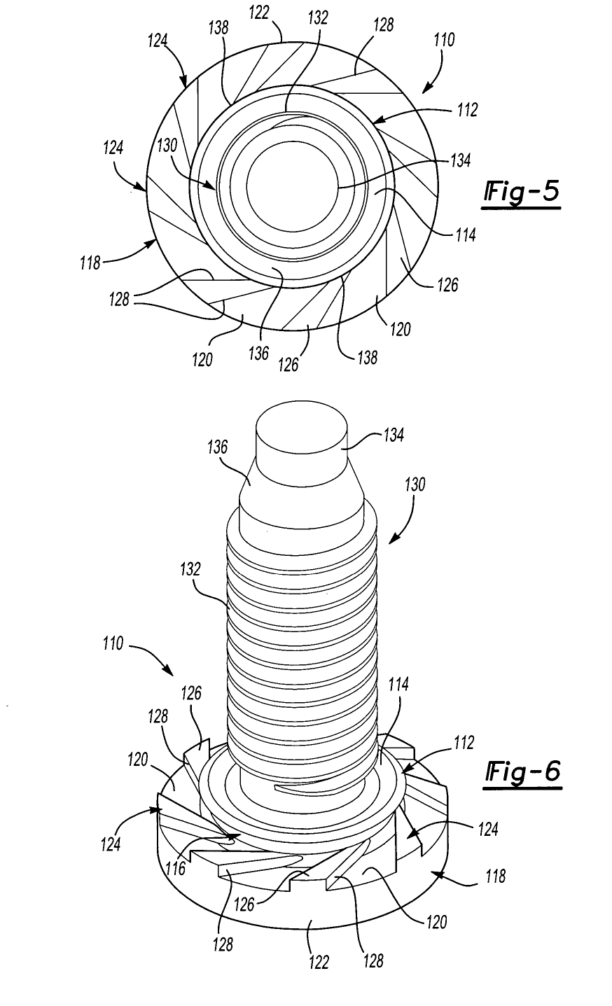

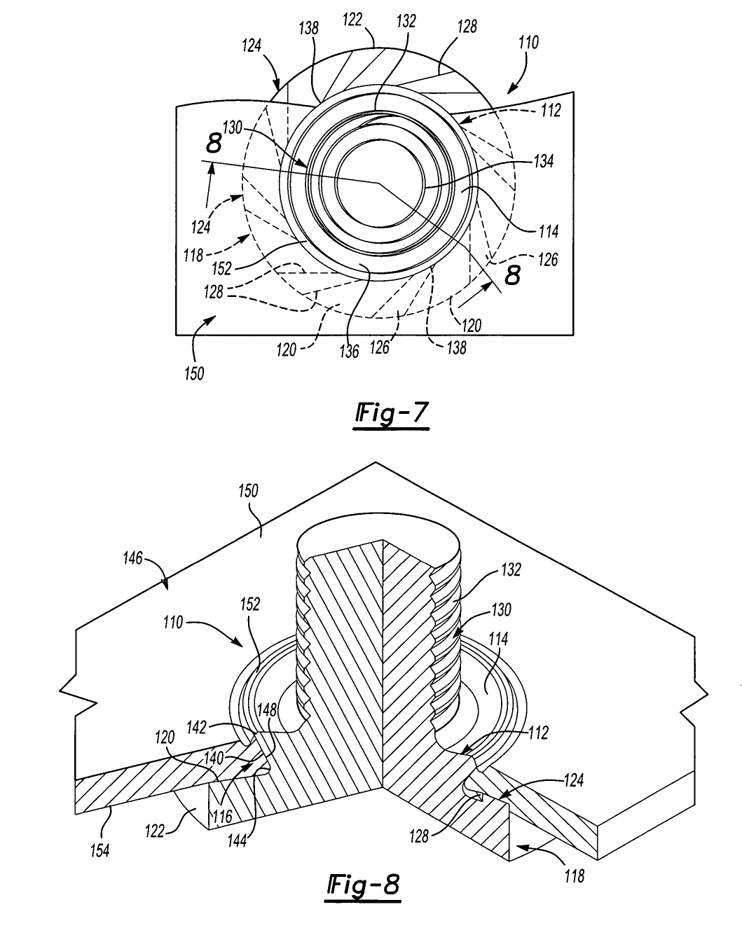

FIGS. 5 and 6 illustrate an alternative embodiment of a self-attaching fastener 110. The elements of the self-attaching fastener 110 has been numbered in the same sequence in the 100 series as the elements of the self-attaching fastener 10 shown in FIGS. 1 and 2 for ease of understanding and to reduce duplication of the description. As shown in FIGS. 5 and 6, the self-attaching fastener 110 includes a body portion 112 having an annular top face 114 which is preferably inclined upwardly, as described above, and an annular concave radial outer surface 116. As shown in FIG. 8, the annular concave radial outer surface 116 includes an inclined face 140 having a convex arcuate surface 142 joining the annular top face 114 with the inclined face 140 and a concave surface 144 joining the inclined face 140 with the annular bearing face 120. The self-attaching fastener 110 further includes a radial flange portion 118 having an annular bearing face 120 including an outer surface 122 and a plurality of circumferentially spaced ribs 124 integral with the frustoconical bearing face 120 each having a generally triangular top face 126 and side faces 128 described further hereinbelow. As described above, the disclosed embodiment of the self-attaching fastener 110 is a male or stud-type fastener including a shank portion 130 coaxially aligned with the body portion 112 and the radial flange portion 118. However, the self-attaching fastener 110 may also be a female fastener as described above, wherein the shank portion 130 is removed and a threaded or unthreaded bore (not shown) is defined through the body portion 112, preferably coaxially aligned with the body portion 112 and the radial flange portion 118.

In the embodiment of the self-attaching fastener 110 shown in FIGS. 5 and 6, the annular bearing face 120 is frustoconical and inclined inwardly and downwardly from the outer surface 122 of the radial flange portion 118, preferably at an angle of between 5 and 15 degrees or about 10 degrees. Further, the opposed side faces 120 of the ribs 24 extend generally tangentially to the annular concave radial outer surface 116 of the body portion as best shown in FIG. 5. However, in this embodiment, the inner ends 138 of the ribs 124 are integral with the annular concave radial outer surface 116 of the body portion 112 and define a smaller angle than the ribs 24 of the embodiment of the self-attaching fastener 10 shown in FIGS. 1 and 2. In this embodiment, the angle formed between the side faces is preferably between about 5 and 20 degrees, or preferably between 10 and 20 degrees or more preferably about 15 degrees and the circumferential width of the bearing face 120 between the ribs 24 is substantially greater than the circumferential width of the ribs, providing a greater area of the bearing faces 120 between the ribs 124. In the disclosed embodiment, the circumferential width of the bearing face 120 between the ribs 124 adjacent the outer surface 122 is about twice the width of the ribs 124 as shown in FIGS. 5 and 6. The inner ends 138 of the ribs 124 are preferably integrally joined to the annular concave radial outer surface 116 of the body portion 112 substantially below the annular top face 114, such that panel metal driven against the top faces 126 of the ribs 124 is driven into the annular concave radial outer surface 116 of the body portion 112, as described further below. In a preferred embodiment, the opposed side faces 128 of the ribs 124 are perpendicular to the bearing face 120 and the triangular top faces 126 are parallel to the frustoconical bearing face 122, such that the top faces 126 are inclined inwardly and downwardly at the same angle as the frustoconical bearing face 120 as best shown in FIG. 6.

The installation of the self-attaching fastener 110 in a panel 150 may be substantially the same as the installation of the fastener 10 in a panel 50 described above. That is, an opening 148 is first formed in the panel having an inside diameter generally equal to or slightly greater than the outside diameter of the body portion 112. The body portion 112 is then received through the panel opening 148 and clinched as described above. The panel opening may initially be cylindrical, but is clinched by a die button having a circular clinching lip (not shown) deforming a circular groove 152 in the top face 150 of the panel, deforming the bottom surface 154 of the panel 150 against the generally triangular top faces 126 of the ribs 124 and against the frustoconical bearing face 120 of the flange portion 118. The frustoconical shape of the bearing face 120 and the inclined top faces 126 of the ribs 124 deforms the metal panel 150 radially inwardly into the annular concave radial outer surface 116 of the body portion 112 and beneath the inclined face 140, preventing push-off of the self-attaching fastener 110 from the panel 150. Further, driving the panel metal around the ribs 124 preferably against the side faces 128 prevents rotation of the fastener 110 relative to the panel 150 following installation. Further, the triangular configuration of the ribs 124 provides improved torque resistance, as described above particularly where the ribs are relatively thin as shown in FIGS. 5 and 6.

As will be understood from the above description of the preferred embodiments of the self-attaching fastener and fastener and panel assembly, various modifications may be made to the fastener and fastener and panel assembly within the purview of the appended claims. As described above, the stud or bolt-type fasteners disclosed may also be female fasteners, wherein the shank portion (30, 130) is removed and the body portion (12, 112) includes a bore preferably coaxially aligned with the body portion and the flange portion (18, 118). The annular bearing face 20 of the embodiment of the self-attaching fastener 10 shown in FIGS. 1 to 4 may also be frustoconical as shown at 120 in FIGS. 6 and 8. The top faces (26, 126) may be parallel to the bearing face (20, 120) as shown in FIG. 6 or the top faces 126 may be perpendicular to the axis of the body portion 112 and the radial flange portion 118, such that the side faces 126 are generally triangular. The ribs (24, 124), including the top faces (26, 126), are preferably triangular for the reasons set forth above. However, other triangular configurations may also be utilized, provided that the circumferential width of the ribs (24, 124) at or adjacent the outer surface (22, 122) is greater than the width adjacent the annular concave radial outer surface (16, 116). Further, the shape of the outer surface (22, 122) of the flange (18, 118) may be any convenient shape, including polygonal. Finally, the annular concave radial outer surface (16, 116) of the body portion (12, 112) may be arcuate or include a plurality of planar faces. Having described the preferred embodiments of the self-attaching fastener and fastener and panel assembly of this invention, the invention is now claimed as follows.

1. A self-attaching fastener for attachment to a panel, comprising:
a body portion having an annular concave radial outer surface; and
a radial flange portion adjacent to and integral with said body portion having a diameter greater than said body portion including a bearing face receiving said panel extending radially from said annular concave radial outer surface of said body portion to an outer surface of said flange portion having a plurality of integral circumferentially spaced ribs projecting from said bearing face each having a circumferential width adjacent said outer surface of said flange portion greater than a circumferential width adjacent said annular concave radial outer surface of said body portion, a top face spaced above said bearing face, and opposed side faces driven into said panel and preventing rotation of said self-attaching fastener relative to said panel, and said panel driven into said annular concave radial outer surface of said body portion preventing push-off of said self-attaching fastener from said panel.

2. The self-attaching fastener for attachment to a panel as defined in claim 1, wherein said ribs are generally triangular in plan view.

3. The self-attaching fastener for attachment to a panel as defined in claim 2, wherein said ribs are in the general shape of an equilateral triangle and said side faces extend generally radially.

4. The self-attaching fastener for attachment to a panel as defined in claim 1, wherein said ribs each include an outer surface at said outer surface of said flange portion and an inner surface spaced from said annular concave radial outer surface of said body portion.

5. The self-attaching fastener for attachment to a panel as defined in claim 4, wherein said inner surface of said ribs is planar.

6. The self-attaching fastener for attachment to a panel as defined in claim 1, wherein said side faces of said ribs extend generally perpendicular to said bearing face of said flange portion.

7. The self-attaching fastener for attachment to a panel as defined in claim 1, wherein said bearing face is concave and frustoconical and angled inwardly toward said annular concave radial outer surface of said body portion from said outer surface of said flange portion.

8. The self-attaching fastener for attachment to a panel as defined in claim 1, wherein said ribs each include an inner end integral with said annular concave radial outer surface of said body portion and spaced below a top face of said body portion.

9. The self-attaching fastener for attachment to a panel as defined in claim 1, wherein said ribs are generally triangular in plan view and said side faces of said ribs extend generally tangentially to said annular concave radial outer surface of said body portion.

10. The self-attaching fastener for attachment to a panel as defined in claim 1, wherein each of said ribs includes an inner end integral with said annular concave radial outer surface of said body portion and said body portion includes an annular top face spaced above said ribs and said top face is inclined upwardly to an outer surface.

11. The self-attaching fastener for attachment to a panel as defined in claim 10, wherein said bearing surface of said flange portion is frustoconical, inclined inwardly toward said annular concave radial outer surface of said body portion from said outer surface of said flange portion.

12. The self-attaching fastener for attachment to a panel as defined in claim 1, wherein said annular concave radial outer surface of said body portion is inclined inwardly from a top surface of said body portion to adjacent said bearing face of said flange portion.

13. The self-attaching fastener for attachment to a panel as defined in claim 1, wherein said self-attaching fastener is a male fastener having a shank portion integral with said body portion coaxially aligned with said body portion and said flange portion.

14. A self-clinching fastener for attachment to a panel, comprising:
a body portion having an annular concave radial outer surface; and an annular frustoconical top face; and
a radial flange portion adjacent to and integral with said body portion having a diameter greater than said body portion including a bearing face extending radially from said annular concave radial outer surface of said body portion to an outer surface of said flange portion having a plurality of integral circumferentially spaced ribs projecting from said bearing face each having a circumferential width adjacent said outer surface of said flange portion greater than a circumferential width of said annular radial concave outer surface of said body portion, a generally triangular top face spaced above said bearing face, opposed side faces extending generally perpendicular to said top face and said bearing face and an inner face spaced from said annular concave radial outer surface of said body portion.

15. The self-attaching fastener for attachment to a panel as defined in claim 14, wherein said ribs are in the general shape of an equilateral triangle and said side faces extend generally radially.

16. The self-attaching fastener for attachment to a panel as defined in claim 14, wherein said inner surfaces of said ribs are planar.

17. The self-attaching fastener for attachment to a panel as defined in claim 14, wherein said annular concave radial outer surface of said body portion is inclined inwardly from a top surface of said body portion to said bearing face of said flange portion and an angle of between sixty and seventy five degrees.

18. The self-attaching fastener for attachment to a panel as defined in claim 17, wherein said annular concave radial outer surface of said body portion includes a convex arcuate surface at said top surface of said body portion and a concave arcuate surface at said bearing face.

19. The self-attaching fastener for attachment to a panel as defined in claim 14, wherein said self-attaching fastener is a male fastener having a shank portion integral with said body portion coaxially aligned with said body portion and said flange portion.

20. A self-attaching fastener for attachment to a panel, comprising:
a body portion having an annular concave radial outer surface and an annular top face; and
a radial flange portion adjacent to and integral with said body portion having a diameter greater than said body portion including a frustoconical concave bearing face inclined inwardly from an outer surface of said radial flange portion to said annular concave radial outer surface of said body portion having a plurality of integral circumferentially spaced ribs projecting from said bearing face each having a circumferential width adjacent said outer surface of said flange portion greater than a circumferential width adjacent said annular concave radial outer surface of said body portion, a generally triangular top face spaced above said bearing face and opposed side faces extending from said bearing face to said top face, said ribs preventing rotation of said self-attaching fastener relative to a panel following installation.

21. The self-attaching fastener for attachment to a panel as defined in claim 20, wherein said ribs are in the general shape of an equilateral triangle and said side faces extend generally perpendicular to said bearing face.

22. The self-attaching fastener for attachment to a panel as defined in claim 20, wherein said ribs each include an inner end integral with said annular concave radial outer surface of said body portion and said top faces of said ribs are spaced below said annular top face of said body portion.

23. The self-attaching fastener for attachment to a panel as defined in claim 20, wherein said top face of said ribs is generally parallel to said frustoconical concave bearing face, such that said top face of each of said ribs is inclined downwardly from said outer surface of said flange portion toward said annular concave radial outer surface of said body portion.

24. The self-attaching fastener for attachment to a panel as defined in claim 20, wherein said side faces of said ribs extend generally tangentially to said annular concave radial outer surface of said body portion.

25. A self-attaching fastener and panel assembly, comprising:
a panel having an opening therethrough;
a self-attaching fastener including a body portion having an annular concave radial outer surface received through said opening of said panel, an annular top face and a radial flange portion adjacent to and integral with said body portion having a diameter greater than said body portion including a bearing face extending radially from said annular concave radial outer surface of said body portion to an outer surface of said flange portion having a plurality of integral circumferentially spaced ribs projecting from said bearing face, each of said ribs having a circumferential width adjacent said outer surface of said flange portion greater than a circumferential width adjacent said annular concave radial outer surface of said body portion and opposed side faces extending generally perpendicular to said bearing face, said ribs driven into said panel, preventing rotation of said self-attaching fastener relative to said panel and said panel driven into said annular concave radial outer surface of said body portion preventing push-off of said self-attaching fastener from said panel.

26. The self-attaching fastener and panel assembly as defined in claim 25, wherein said bearing face of said flange portion is frustoconical and inclined inwardly from said outer face of said flange portion toward said annular concave radial outer surface of said body portion, and said panel driven against said frustoconical bearing face into said annular concave radial outer surface of said body portion.

27. The self-attaching fastener and panel assembly as defined in claim 25, wherein said ribs each include an inner face spaced from said annular concave radial outer surface of said body portion, and said panel driven between said ribs and said annular concave radial outer surface of said body portion.

28. The self-attaching fastener and panel assembly as defined in claim 25, wherein said annular concave radial outer surface of said body portion is generally V-shaped including a face inclined inwardly from said annular top face of said body portion to said bearing face of said flange portion, at an angle of between sixty and seventy five degrees and said panel driven against said inclined face of said annular concave radial outer surface of said body portion.

29. The self-attaching fastener and panel assembly as defined in claim 28, wherein an annular groove is deformed into a top face of said panel surrounding said top face of said body portion deforming said panel against said bearing of said flange portion and into said annular concave radial outer surface of said body portion.
